(19) United States
(12) Patent Application Publication
(10) Pub. No.: US 2023/0214715 A1
(43) Pub. Date: Jul. 6, 2023

(54) DATA PROGRAMMING METHOD FOR SUPPORTING ARTIFICIAL INTELLIGENCE AND CORRESPONDING SYSTEM

(71) Applicant: NEC Laboratories Europe GmbH, Heidelberg (DE)

(72) Inventors: BIN CHENG, Heidelberg (DE); JONATHAN FUERST, Heidelberg (DE); MAURICIO FADEL ARGERICH, Heidelberg (DE)

(21) Appl. No.: 18/000,693

(22) PCT Filed: Sep. 3, 2020
(86) PCT No.: PCT/EP2020/074635

§ 371 Date: Dec. 5, 2022

(30) Foreign Application Priority Data
Jun. 9, 2020 (EP) 20179071.4

(51) Int. Cl. G06N 20/00; G06N 7/01

(52) U.S. Cl. CPC G06N 20/00; G06N 7/01

(57) ABSTRACT

A data programming method is provided for supporting artificial intelligence systems, wherein shareable labeling functions for labeling data are used. The method includes: providing at least two shareable labeling functions with their profile across domains, wherein each of the at least two shareable labeling function profiles includes at least one training-related performance metric; selecting at least one of these shareable labeling functions by a selecting domain, wherein the selecting is based on the labeling functions' at least one performance metric; grouping unlabeled data of the selecting domain for providing at least one group, wherein this grouping step is based on a definable degree of coverage of the selected shareable labeling function per unlabeled data, and training a preferably generative machine learning model of the selecting domain per at least one group with the labeling functions' respective at least one performance metric for producing labeled data or labels.

### CROSS REFERENCE TO RELATED APPLICATIONS

This application is a U.S. National Phase application under 35 U.S.C. § 371 of International Application No. PCT/EP2020/074635, filed on Sep. 3, 2020, and claims benefit to European Patent Application No. EP 20179071.4, filed on Jun. 9, 2020. The International Application was published in English on Dec. 16, 2021, as WO 2021/249662 A1 under PCT Article 21(2).

### FIELD

The present invention relates to a data programming method for supporting artificial intelligence, AI, systems, particularly in the field of machine learning, ML. Further, the present invention relates to a system for carrying out a data programming method for supporting artificial intelligence, AI, systems, particularly in the field of machine learning, ML.

### BACKGROUND

Nowadays, AI systems rely more and more on data, especially high-quality labelled data, to train advanced models so that they can utilize the trained models to make intelligent decisions. Usually, data are generated and located within different silos, hosted and managed by different data owners, organization parties, or geographically distributed devices. For example, in the eHealth area, different hospitals and clinics host different parts of the treatment data for the same patient or different patients. Similar situations can be seen also in the other business domains like financial, smart manufacturing, and connected vehicles. For example, different banks would not be able to share or exchange their customer information due to user privacy and data security, even though they see the big potential of combining all customer data to learn advanced AI models for various business purposes, e.g. recommending proper financial services to their customers, or detecting financial fraud. In terms of smart manufacturing and connected vehicles, each individual robot or car can produce its own data. The data size is large and difficult to upload to the central cloud for further data analytics and model training. Also, manually labeling a large amount of data is costly due to its required human effort.

To empower the AI systems in those business domains, there is a strong need to leverage the data across all data silos, especially lots of unlabeled data available inside each silo. To maximize the value of the data located in different domains, one way is to establish a marketplace or data trading platform among different data owners to exchange their data directly. The biggest problem with this approach is that, once the data are sent out to the consumers, the data owners will lose the control of their data and therefore it becomes very difficult to ensure and apply data privacy and protection regulations, such as General Data Protection Regulation, GDPR, defined by the European Union, EU, to protect all EU citizens from privacy and data breaches in today's data-driven world. Besides the privacy and data regulation reason, there are also some other reasons why moving data from one domain/device to another is problematic or impossible. For example, in terms of connected vehicles, each of them will generate 5-20 TB data per day, including all data generated by multiple mounted cameras and many other sensors like LIDAR, RADAR and GPS. Moving the constantly generated data across vehicles or from vehicles to the central cloud will introduce very high bandwidth cost.

In the state of the art, three types of related studies are proposed:

First, federated learning has been proposed as a promising approach to coordinating model AI training over distributed data sets without sharing original raw data, however, this approach focuses on the model training phase, rather than the data labeling phase. It has the following limitations: 1) it requires a centralized parameter server to do the fine-grained coordinating of the entire training process over all clients—there is a client running for each domain or site—, but the centralized parameter server could be the bottleneck and a single point of failure for the training processing; 2) labelled data must be available on each client, which is not the case in many real world scenarios; 3) it is not model agonistic because it required the trained model to be the same kind for every client, which limits the flexibility for each domain to use and select a suitable trained model for its own domain.

Second, a data programming method like Snorkel provides a way of training a discriminative model out of unlabeled data by using a set of expert-coded labeling functions, however, this approach requires model developers to hold all unlabeled data for the training with labeling functions, which is a big drawback of this approach in terms of data security and privacy. Existing data programming approaches like Snorkel are limited by sparse voting of labeling functions and also availability of training data due to data security and use privacy regulation, e.g. GDPR.

Third, transfer learning can turn a generic model for task A into a specific model for task B by using a few new samples. It can increase sample efficiency and reduce labeling functions by reusing a pre-trained model. But it requires the model types to be the same kind and also the knowledge is transferred over labelled data for the model training phase, not for the labeling phase. It could not transfer knowledge over unlabeled data sets.

### SUMMARY

In an embodiment, the present disclosure provides a data programming method for supporting artificial intelligence (AI) systems, wherein shareable labeling functions for labeling data are used. The data programming method comprises: providing or publishing at least two shareable labeling functions with their profile across domains, wherein each of the at least two shareable labeling function profiles includes at least one training-related performance metric and/or weight; selecting at least one of the at least two shareable labeling functions by a selecting domain, wherein the selecting is based on respective at least one training-related performance metric and/or weight of the at least two shareable labeling functions; grouping unlabeled data of the selecting domain for providing at least one group, wherein the grouping is based on a definable degree of coverage of the selected at least one shareable labeling function per unlabeled data and/or on a definable degree of coverage of unlabeled data per shareable labeling function; and training a preferably generative machine learning model of the selecting domain per at least one group with the respective at least one training-related performance metric and/or weight for producing labeled data of the selected at least one shareable labeling functions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows in a diagram a workflow of a federated data programming approach or data programming method according to an embodiment of the invention:

FIG. 2 shows in a diagram a process to select a set of labeling functions from a function catalog according to an embodiment of the invention;

FIG. 3 shows in a diagram a potential estimation of a labeling function based on feedback from other domains according to an embodiment of the invention;

FIG. 4 shows in a graph a voting matrix provided by labeling functions according to an embodiment of the invention; and

FIG. 5 shows in a diagram a federated data programming system or system for carrying out the data programming method according to an embodiment of the invention.

### DETAILED DESCRIPTION

In an embodiment, the present invention improves and further develops a data programming method and a corresponding system for providing a particularly effective machine learning with simple means.

In another embodiment of the present invention, provides a data programming method for supporting artificial intelligence, AI, systems, particularly in the field of machine learning, ML, wherein shareable labeling functions for labeling data are used, comprising the steps:
providing or publishing at least two of said shareable labeling functions with their profile across domains, wherein such a labeling function profile includes at least one training-related performance metric and/or weight;
selecting at least one of these shareable labeling functions by a selecting domain, wherein this selecting step is based on the labeling functions' respective at least one performance metric and/or weight,
grouping unlabeled data of said selecting domain for providing at least one group, wherein this grouping step is based on a definable degree of coverage of the selected shareable labeling function or functions per unlabeled data and/or on a definable degree of coverage of unlabeled data per shareable labeling function; and
training a preferably generative machine learning model of said selecting domain per at least one group with the labeling functions' respective at least one performance metric and/or weight for producing labeled data or labels.

In another embodiment, the present invention provides a system for carrying out a data programming method for supporting artificial intelligence, AI, systems, particularly in the field of machine learning, ML, wherein shareable labeling functions for labeling data are used, comprising:
providing or publishing means adapted for providing or publishing at least two of said shareable labeling functions with their profile across domains, wherein such a labeling function profile includes at least one training-related performance metric and/or weight;
selecting means adapted for selecting at least one of these shareable labeling functions by a selecting domain, wherein this selecting is based on the labeling functions' respective at least one performance metric and/or weight;
grouping means adapted for grouping unlabeled data of said selecting domain for providing at least one group, wherein this grouping is based on a definable degree of coverage of the selected shareable labeling function or functions per unlabeled data and/or on a definable degree of coverage of unlabeled data per shareable labeling function; and
training means adapted for training a preferably generative machine learning model of said selecting domain per at least one group with the labeling functions' respective at least one performance metric and/or weight for producing labeled data or labels.

According to the invention it has been recognized that it is possible to provide a very efficient data programming method and a corresponding system for carrying out the data programming method by sharing labeling functions and their performance metric and/or weight across domains for allowing each domain to leverage the knowledge coming from at least one other remote domain. By this method and system is provided a high scalability degree, because the communication cost for exchanging label functions and their weights is low and also there is no need of a centralized coordinator.

Thus, on the basis of the invention a particularly effective machine learning with simple means is provided.

According to an embodiment of the invention a profile of the labeling function can include a semantically annotated data dependency and/or can be a semantically annotated profile. As a result, sharing of labeling functions across users is possible in a very simple way.

Within a further embodiment a profile of the labeling function can include a semantic type of input and output data and/or estimated performance metrics and/or an estimated computation time and/or a partitioning granularity and/or a provider profile and/or third-party data sources and/or a labeled data set. A semantic type of input and output data can be specified based on the same shared ontology. An estimated computation time can be the estimated execution time of such a labeling function over various environment settings, for example, with a single CPU, GPU or TPU. A partitioning granularity can be the factor to partition the input data in order to run the labeling function in parallel. A provider profile can be the profile of a user or domain that publishes such labeling functions. A third-party data source can be the data source information that is provided by a third-party but used inside the labeling function for labeling data. A labeled data set can be a small labeled data set that could be shared without privacy issue and could be also utilized by the other domains to evaluate the performance of various labeling functions.

According to an embodiment the estimated or at least one training-related performance metric can comprise the estimated capability to produce correct labels for a certain size of data, preferably in terms of different types of machine learning measures, for example accuracy, precision, recall and F1-score. This provides a very effective machine learning with simple means.

Within a further embodiment the at least one training-related performance metric and/or weight can be generated from one or more domains other than the selecting domain. Thus, a leverage of knowledge of other domains is easily possible.

According to a further embodiment an initial selecting of said at least one of these shareable labeling functions by a selecting domain can be carried out based on a matching between a provided data schema and the annotated input of all labeling functions. By checking the annotated outputs of all matched labeling functions, the selecting domain or selecting user can select a broad set of labeling functions.

Within a further embodiment the selecting step can additionally be based on labeled data of the selecting domain and/or a ground-truth data set of the selecting domain. Further adjusting the weight of each labeling function is possible in this way.

According to a further embodiment each labeling function, once it has been provided or published from a domain, can be selected and estimated by preferably all other domains. Further effectiveness of machine learning can be provided in this way.

Within a further embodiment the grouping step can comprise a production of a probabilistic label for one or more or all unlabeled data.

According to a further embodiment at least one estimated performance metric and/or weight of the selected labeling functions in each group and/or the number of samples in the group can be reported to other domains. Simple sharing of relevant information is possible by this proceeding.

Within a further embodiment a preferably discriminative and/or preferably local machine learning model of the selecting domain can be trained using the produced labeled data or produced labels.

Within a further embodiment low-quality labeling functions can be filtered out from provided or published or shared labeling functions. This can lead to a significant increase of F1 score, as compared to the case without filtering.

According to a further embodiment published labeling functions can be maintained by a function catalog or function catalog server, the function catalog or function catalog server preferably comprising a global ontology and/or a function repository and/or a propagator. Thus, a simple and effective storing of published labeling functions and also a simple and effective access to published labeling functions is possible.

Within a further embodiment at least one domain can comprise or run an agent that comprises a function publisher and/or a function selector and/or a label producer and/or a local model learner. This provides a very effective data programming and machine learning method with simple means.

Advantages and aspects of embodiments of the present invention are summarized as follows:

In order to train a machine learning model out of unlabeled data jointly across different domains without violating privacy regulations, embodiments of this invention introduce a federated data programming method. Based on embodiments of the invention, a set of pre-defined or pre-trained labeling functions can be exchanged across domains and then each domain can dynamically select a customized set of labeling functions according to its own requirement and its local data set and then ensemble them to train its own generative model for producing labelled data, which can be later utilized to train any machine learning model. Different from traditional federated learning methods, a method according to embodiments of the invention does not require a centralized server to coordinate the learning process across domains and also does not require each domain to have labelled data. Also, as compared to the existing data programming approach like Snorkel, such a method does not need to collect all unlabeled data for local training while still being able to leverage the knowledge from other remote domains to improve the training process in the local domain by exchanging the evaluated weights and performance metrics of all label functions across domains.

Embodiments of the invention provide one or more of the following technical features and/or advantages: 1) privacy-preserving, because only the label functions and their weight are exchanged across domains but the original data stay within its own domain; 2) high efficiency, because sharing labelling functions and their evaluated weights across domains allows each domain to leverage the knowledge coming from other remote domains; 3) high scalability, because the communication cost for exchanging label functions and their weights is low and also there is no need of centralized coordinator; 4) avoid cold-start problem of traditional machine learning, because labeled data are not required and any existing knowledge can be directly used as labeling functions; 5) enable model-agnostic learning for each personalized domain and allow each domain to train its own personalized model adaptive to its own data distribution and environment.

Further advantages and aspects of embodiments of the present invention are summarized as follows:
1) There are used sharable labeling functions for cross-domain training of generative models, including:
   1a. publishing labeling functions along with their annotated profiles, small labelled datasets, and also their weights estimated according to a large unlabeled data set in the local or selecting domain;
   1b. selecting published labeling functions for the training of a local model based on their calculated potential;
2) There are grouped samples based on their coverage of labeling functions and then trained generative models per group with the shared weights of labeling functions across groups;

Embodiments of this invention provide a method for producing high quality labelled data to train a local machine learning model over unlabeled data by sharing semantically annotated labeling functions and their estimated weights and performance metrics across domains.

Such a method can comprise the steps of
1) publishing all kinds of sharable labeling functions with their profiles, including:
   a. semantically annotated data dependency
   b. training-related performance metrics and weights that are generated and reported from the other domains in Step 4);
2) selecting a set of labeling functions based on their potentials that can be estimated and learned from the provided profile information and a local small ground-truth data set;
3) grouping samples based on their coverage of labeling functions and then training generative models per group with the shared weights of labeling functions across groups;
4) report the evaluated weights and performance metrics of the selected label functions;
5) training a local machine learning model using the produced labels.

To overcome the limitations of prior art, embodiments of this invention introduce a federated data programming method and system to share labeling functions and their estimated weights and performance metrics across domains so that a more accurate local machine learning model can be trained out of unlabeled data without sharing raw data. Existing approaches cannot utilize unlabeled data across domains for training machine learning models without violating privacy and data security.

Instead of moving data to labeling for learning a single global model, embodiments of this invention are to move labeling functions to data for learning any local model, which can still benefit from the knowledge transferred from the other domains in the label generation phase. Since the knowledge can be transferred from one domain to another domain in the label generation phase by sharing labeling functions and their learned weights and estimated performance metrics, training the local model is model-agonistic and can be done with largely reduced labeling cost.

Embodiments of the invention enable collaborative AI systems across domains for data integration, digital health and financial services, for example, at low labeling cost and in a privacy-preserving manner.

There are several ways how to design and further develop the teaching of the present invention in an advantageous way. To this end it is to be referred to the following explanation of examples of embodiments of the invention, illustrated by the drawing. In the drawing

In this document the term “domain” and “domain user” are used synonymously.

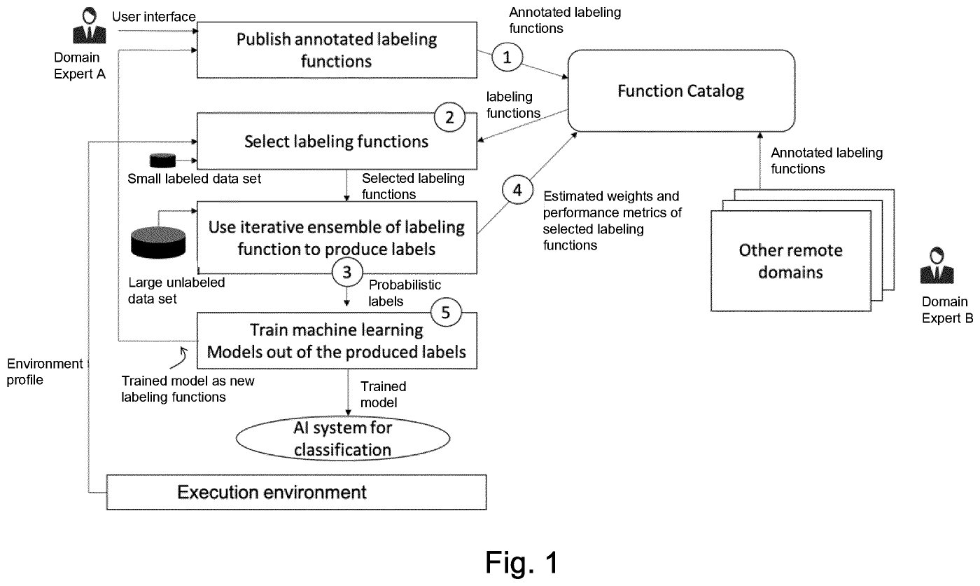

A detailed workflow of a data programming method according to an embodiment of the invention is illustrated in FIG. 1, wherein each major step is described as below.

Step 1: Publishing all Kinds of Sharable Labeling Functions with their Profile, which Includes Performance-Related Metrics and Also Semantically Annotated Data Dependency:

Labeling functions are proposed by the existing data programming method to produce labels for unlabeled data based on different types of domain knowledges, such as rules, patterns, heuristic distance, pre-trained models. However, labeling functions in the existing data programming approach like Snorkel are limited for a specific user to address a specific problem in a specific domain with a specific data set. In the state-of-the-art, there is no mean to automatically share labeling functions across users, problems, domains, and data sets. To overcome this limitation, “shareable labeling functions” are proposed, that can make labeling functions transferable and reusable across users, problems, domains, and data sets via their semantically-annotated profiles.

Each shareable labeling function is annotated with the following profile:
Semantic type of Input and output data: the semantic types of input and output data for all labeling functions will be specified based on the same shared ontology, for example, https://schema.org/;
Estimated performance metrics: the estimated capability to produce correct labels for a certain size of data, in terms of many or all different types of machine learning measures, such as accuracy, precision, recall, and F1-score, wherein the F1-score is known as a measure of a test's accuracy in analysis;
Estimated computation time: the estimated execution time of such labeling function over various environment settings, for example, with a single CPU, GPU, TPU. This is supposed to be a rough measure of the computation overhead of the label function per each input sample;
Partitioning granularity: the factor to partition the input data in order to run the labeling function in parallel;
Provider profile: the profile of the user or domain that publishes such labeling functions, for example, a reputation score of the provider could be included to indicate how trustful this labeling function is;
Third-party data sources: the data source information that is provided by a third-party but used inside the labeling function for labeling data. For example, some labeling function might use the knowledge information from OpenStreetMap to map geo-coordination to street number;
Small labelled data set that could be shared without privacy issue and could be also utilized by the other domains to evaluate the performance of various labeling functions.

A part of profile information of a labeling function is initially provided by domain experts, such as its basic profile information like input/output data type, partitioning granularity, provider profile, and third-party data sources. After that, the other parts like estimated performance metrics and computation time will be added and adjusted automatically at runtime.

To make such a labeling function shareable and applicable across domains, in this embodiment its input and output data will be semantically annotated according to a global ontology, such as https://schema.org/.

All published labeling functions are maintained by a function catalog to store the profiles of labeling functions and also to keep track of their reported performance metrics and computation times.

Step 2: Selecting a Set of Labeling Functions Based on their Potentials that can be Estimated and Learned from the Provided Profile Information and a Local Small Ground-Truth Data Set:

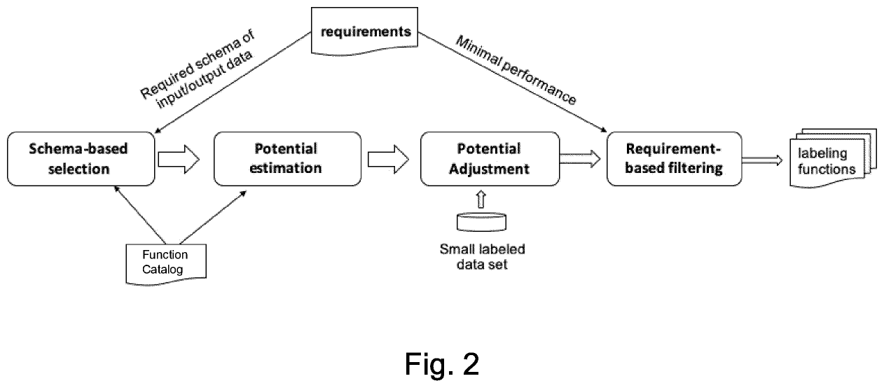

As illustrated by FIG. 2, the following four steps are designed to select a set of labeling functions for the learning of a generative model.

### Step 2.1 Schema-Based Selection

When selecting labeling functions from the function catalog, the domain or domain user needs to provide the schema of the original data set X, which is the data to be labelled for training a local machine learning model. The initial selection of labeling function is carried out based on the matching between the provided data schema and the annotated input of all labeling functions. By checking the annotated outputs of all matched labeling functions, the domain or domain user can select a broad set of labeling functions from the function catalog.

### Step 2.2 Potential Estimation

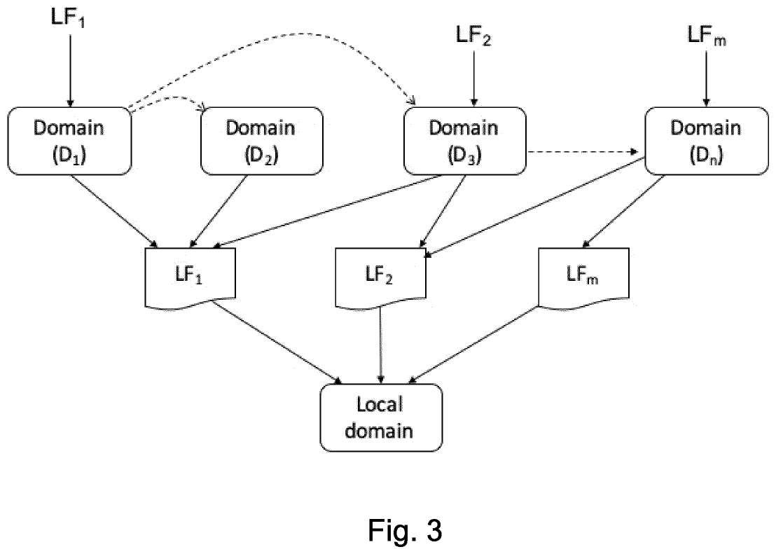

For each labeling function, once it has been published from the original domain, it will be selected and estimated by the other domains, see Step 4. As illustrated in FIG. 3, after more and more domains have estimated and reported the performance of this labeling function, the latter one will have more reference information to estimate the overall potential of a labeling function.

Assume that, for a matched labeling function, LF, K performance estimations (e¹, e², e³, . . . e^{k}) have been collected from the other domains in the past and each estimation is an array including multiple performance metrics (accuracy, precision, recall, f1). The potential of this labeling function can be estimated as below.

$$Potential ( LF ) = \frac{1}{k} {\sum }_{i = 1}^{k} {w}^{i} * {e}^{i}$$

where, wⁱ is the weight of a reported estimation (eⁱ) with regards to the size of the data set that the estimation was calculated and the reputation score of the domain.

### Step 2.3 Potential Adjustment

If small labeled data is provided in the local domain and/or published by other domains, it can be utilized as the ground-truth to further adjust the weight of each labeling function. The exemplary method is to take the labeled data as Y and then learn a generative model based on the selected labeling functions. When learning this generative model, the estimated potential of the selected labeling functions will be used to calculate their initial weights. Meanwhile, the performance of each labeling function can be estimated against the provided ground-truth and then reported back to a Function Catalog for sharing.

### Step 2.4 Requirements-Based Filtering

To avoid any low-quality labeling function, a minimal performance requirement will be given to filter out some labeling functions from the selected labeling functions. The minimal performance requirement can be defined in terms of required accuracy, precision, recall, and f1-score. In addition, a threshold in terms of computation time can be provided to filter out some computation intensive labeling functions.

Step 3: Grouping Samples Based on their Coverage of Labeling Functions and then Training Generative Models Per Group with the Shared Weights of Labeling Functions Across Groups

Once a set of labeling functions are selected, they can be used to train a generative model over a large amount of unlabeled data in the local domain to produce labeled data for the training of a discriminative model. In practice, different labeling functions lead to different performance and different coverage of the sample data. For example, some labeling functions are very conservative, meaning that they only provide their voting results for the samples they are very sure about, therefore leaving the voting results of all the other samples empty. In contrast, some labeling functions could be much more relaxed, meaning that they try to provide the best voting results for every sample. Therefore, not all samples could have the same number of votes from labeling functions and not all labeling functions can cover the same number of samples. The existing data programming approach like Snorkel can build a generative model from the voting results of all labeling functions, but this approach is just to maximize the agreement and minimize the disagreement of all labeling functions over the entire data set. It is not able to deal with the impact of empty voting results, because the overall optimization is done based on the assumption that all voting results have the same weight.

Embodiments of this invention introduce a coverage-based boosting method to do the optimization for each separated sample group, but still allowing different groups to share the weights of overlapped labeling functions. More specifically, the following two types of coverages are considered by this invention:

Coverage of labeling functions per sample: for each sample in the unlabeled data set, the number of labeling functions that can provide a non-empty voting for this sample divided by the total number of all selected labeling function is the function coverage of this sample.
Coverage of samples per labeling functions: for each data point, a labeling function can output a vote, e.g. a class to which this data point belongs to, or it can also abstain. For each labeling function, the number of samples it votes divided by the total number of samples is the sample coverage of this labeling function.

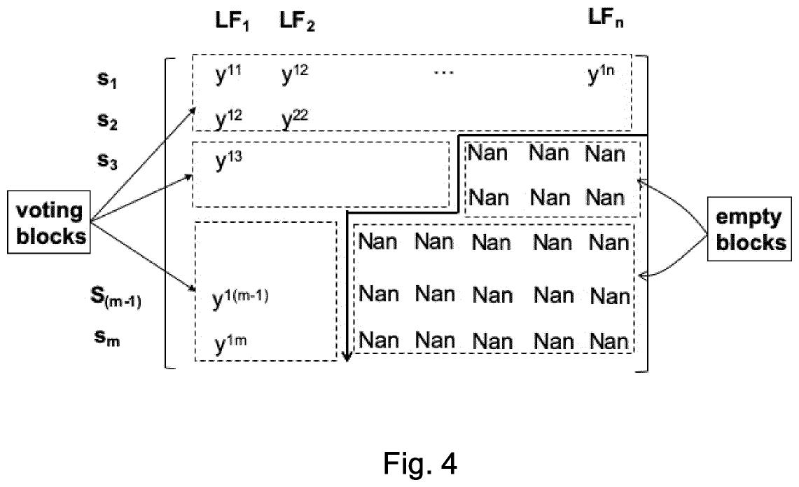

With the definitions above, embodiments of the invention introduce the following method to train generative models out of the unlabeled data to produce high quality labels. Assume that there are m samples in the unlabeled data set and n labeling functions selected from the previous step, as illustrated in FIG. 4.

Step 3.1: calculate the function coverage of all samples in the unlabeled data set and then sort all samples based on their function coverage in descending order;
Step 3.2: divide the sorted samples into k groups so that all samples in each group can have similar or the same function coverage;
Step 3.3: identify the union of labeling functions Uᵢ, 1<=i<=k for each group Gᵢ;
Step 3.4: inside the group Gᵢ, sort the labeling functions based on their sample coverage;
Step 3.5: calculate the weight of all labeling functions in Uᵢ, for the first group, the initial weights of labeling functions are taken from the previous step; for the other groups, the initial weights of labeling functions are estimated based on their weights calculated in the previous group Uᵢ₋₁;
Step 3.6: remove the empty results and then train a generative model based on the voting results and weights of all labeling functions in Uᵢ;
Step 3.7: use the learned generative model to produce the probabilistic labels for all samples in the current group Gᵢ and then calculate the weights of all labeling functions in Uᵢ;
Step 3.8: go back to Step 3.3 until finishing the last group Gₖ. In the end, probabilistic label can be produced for all unlabeled data.

i, k, m and n are integers.

### Step 4: Sharing the Evaluated Weight of the Selected Label Functions

Report the estimated weights of labeling functions in each group Gᵢ and also the number of samples in the group. This information will be propagated to the other domains for sharing.

### Step 5: Training a Local Machine Learning Model Using the Produced Labels

With the produced probabilistic labels, the local domain can train a discriminative model that can be directly applied into the AI system in the local domain. With the invented federated data programming, the coordination across domains is carried out by sharing labeling functions and their weights to improve the process of producing labels. Therefore, the local domain can have the full freedom to select the discriminative model. The improvement of the discriminative model relies on the quality of produced labels.
Federated data programming system for collaborative labelling and learning across domains according to an embodiment of the invention

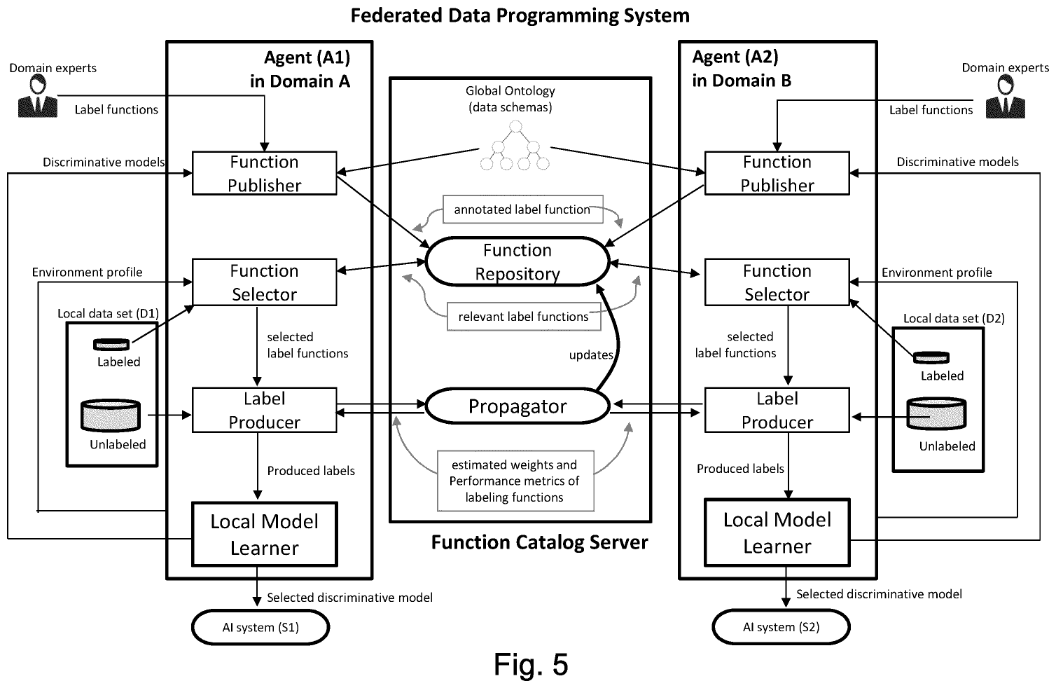

Based on embodiments of the invented method, a federated data programming system according to an embodiment of the invention is realized as shown in FIG. 5. The entire system consists of one centralized Function Catalog Server or Function Catalog and lots of distributed agents that are located at different domains.

The Function Catalog Server of Function Catalog has three major components: Global Ontology that stores and maintains the global semantic types for each domain to annotate labeling functions; Function Repository that stores and indexes all published labeling functions from all domains; Propagator that works as a bridge to exchange the estimated weights and performance metrics of each labeling functions across domains.

Each domain runs one agent that consists of the following four components.
1) Function Publisher, which is responsible for publishing labeling functions to Function Repository. First, it provides the user interface for domain experts to submit a labeling function with its profile and also implementation image, e.g. a docker image that could be executed over any docker environment. The input and output of this labeling function are semantically annotated according to a global data schema from Global Ontology. Second, the function publisher provides APIs to publish labeling functions and update their profiles in a programmable way.
2) Function Selector, which is to fetch all relevant labeling functions that could be applied to label a local data set of a domain or selecting domain. The local data set includes mainly unlabeled data and a small amount of labelled data. The function selector can automatically select a set of suitable labeling functions out of the relevant label function set and weight them based on their contribution potentials, which can be calculated from their reported performance metrics and also a local evaluation process against the small labelled data in the local data set. The output of the Function Selector is a set of selected labeling functions and their estimated weights.
3) Label Producer, which applies the selected labelling functions to the unlabeled data in the local data set and then produce labelled data via an iterative ensemble process that can consider two types of coverages: a) Coverage of labeling functions per sample, b) Coverage of samples per labeling functions.
4) Local Model Learner, which can learn a discriminative model by using the produced labels. The discriminative model can be any type that is suitable to the local domain in terms of training time and prediction time. The trained discriminative model could be directly applied by the local AI system to make decisions. In addition, it could be further provided as new labeling functions via the API of Function Publisher.

Embodiments of the system comprise processors adapted to read machine-readable codes for performing embodiments of the above mentioned data programming method.

Use Cases

Use case 1: collaborative data integration across cities: cities face a big challenge in data integration because they have to deal with data silos and a large mount heterogenous data in their digitalization process. For example, different cities have different data formats, e.g. CSV files, JSON objects, relational databases, for their existing data sources, such as road traffic data, temperature sensor data, air quality measurements, light sensor data, parking sensor data, bin usage monitoring sensor data, city financial reports. To maximize the value of their data, they like to harmonize all available data into linked data in a knowledge graph so that data can be utilized to achieve more revenue. However, the current data integration is carried out individually in each domain by domain experts to write some rule-based convert or apply some heuristic approaches, because very often the data could not be shared across domains because of user privacy and data security. This introduces lots of manual effort duplicated across domains and it is costly. Machine learning based approaches are promising to automate this data integration process, but their effectiveness is limited by the lack of ground truth data. The federated data programming system according to an embodiment of the invention can reuse those rule-based or heuristic algorithms as labeling functions to automatically train various machine learning models with lots of unlabeled data—distributed inside each city domain—to automate the local data integration process without asking each domain to share their data. For example, training a machine learning model for schema matching, data cleaning, entity matching.

Use case 2: collaborative patient diagnosis across hospitals: In a worldwide pandemic like COVID-19, hospitals all around the world will be busy with fighting a highly infectious disease. The patient information about the symptoms and some medical measurements is collected by different hospitals. However, for a new disease, the doctors in each hospital might not be able to judge the disease correctly because they are lack of knowledge about this disease and each hospital might only see the situation in their local region. Due to the user privacy issue, sharing of detailed patient data, e.g. medical imaging like CT scans and Chest X-rays, symptoms, diagnoses, treatments, inpatient care, cannot be done across all hospitals, however, using an embodiment of the invented federated data programming approach, heuristic knowledge given by experienced doctors from all hospitals can be quickly shared and utilized by each hospital to train an advanced diagnosis model to judge whether a patient has the disease or not. This approach can not only avoid the privacy problem, but also reduce the dependency of lots of labelled data.

Use case 3: fraud detection in credit card transactions across banks/credit providers: fraud has been a major issue in sectors like banking, medical, insurance, and many others. Due to the increase in online transactions through different payment options, such as credit/debit cards, different types of fraudulent activities have also increased. The biggest challenge of fraud detection is to detect unusual behavior in transactions which is not detected previously. For a new fraudulent activity, it might be identified by some bank first with a few samples. Since this is a new fraud, many other banks might not be able to detect it in their own banking systems, even though this fraud might already happen and recorded there, but just as unlabeled data samples. Using a federated data programming approach according to an embodiment of the invention, the detection rules or heuristic algorithms are introduced by the domain experts in the banks, which could first detect the new fraud, will be shared across banks and used to train an advanced model together with the knowledge from the unlabeled samples from all banks. In this case, every bank can benefit from this collaborative labelling to train an advanced model quickly and with low cost.

The effectiveness of embodiments of the invention and corresponding inventive steps has been evaluated in an experiment for Use Case 1—collaborative data integration across cities—in terms of supporting machine learning based ontology matching. Within this experiment, it is assumed that there are two city domains, City A and City B, and each city has ten labeling functions to be shared across domains for the purpose of training an ontology matching model. Using the proposed way of selecting labeling functions for the local model training, each domain is able to filter out the low quality noisy labeling functions from shared labeling function candidates and the filtering can lead to a 20% increase of F1 score, as compared to the case without filtering. Furthermore, it is compared the performance of created generative models when applying sample grouping and reusing labeling function weights across groups. It can improve the quality of produced labels. For example, it increases the number of true positive labels—meaning matched cases, which are the minority—by 30-50%.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A data programming method for supporting artificial intelligence (AI) systems, wherein shareable labeling functions for labeling data are used, wherein the data programming method comprises:
providing or publishing at least two shareable labeling functions with their profile across domains, wherein each of the at least two shareable labeling function profiles includes at least one training-related performance metric and/or weight;
selecting at least one of the at least two shareable labeling functions by a selecting domain, wherein the selecting is based on respective at least one training-related performance metric and/or weight of the at least two shareable labeling functions;
grouping unlabeled data of the selecting domain for providing at least one group, wherein the grouping is based on a definable degree of coverage of the selected at least one shareable labeling function per unlabeled data and/or on a definable degree of coverage of unlabeled data per shareable labeling function; and
training a preferably generative machine learning model of the selecting domain per at least one group with the respective at least one training-related performance metric and/or weight for producing labeled data of the selected at least one shareable labeling functions.

2: The data programming method according to claim 1, wherein a profile of the labeling function includes a semantically annotated data dependency and/or is a semantically annotated profile.

3: The data programming method according to claim 1, wherein a profile of the labeling function includes a semantic type of input and output data and/or estimated performance metrics and/or an estimated computation time and/or a partitioning granularity and/or a provider profile and/or third-party data sources and/or a labeled data set.

4: The data programming method according to claim 1, wherein the at least one training-related performance metric comprises an estimated capability to produce correct labels for a certain size of data.

5: The data programming method according to claim 1, wherein the at least one training-related performance metric and/or weight is generated from one or more domains other than the selecting domain.

6: The data programming method according to claim 1, wherein an initial selecting of the at least one of these shareable labeling functions by a selecting domain is carried out based on a matching between a provided data schema and the annotated input of all labeling functions.

7: The data programming method according to claim 1, wherein the selecting step is additionally based on labeled data of the selecting domain and/or a ground-truth data set of the selecting domain.

8: The data programming method according to claim 1, wherein each of the at least two shareable labeling functions will be selected and estimated by all other domains.

9: The data programming method according to claim 1, wherein the grouping step comprises a production of a probabilistic label for one or more or all unlabeled data.

10: The data programming method according to claim 1, wherein at least one estimated performance metric and/or weight of the selected labeling functions in each group and/or the number of samples in the group is or are reported to other domains.

11: The data programming method according to claim 1, wherein a discriminative and/or local machine learning model of the selecting domain is trained using the produced labeled data or produced labels.

12: The data programming method according to claim 1, wherein low-quality labeling functions are filtered out from provided or published or shared labeling functions.

13: The data programming method according to claim 1, wherein published labeling functions are maintained by a function catalog or function catalog server, the function catalog or function catalog server.

14: The data programming method according to claim 1, wherein at least one domain comprises or runs an agent that comprises a function publisher and/or a function selector and/or a label producer and/or a local model learner.

15: A system for carrying out a data programming method for supporting artificial intelligence (AI) systems,
wherein shareable labeling functions for labeling data are used, the system comprising:
one or more memories storing program steps; and
one or more processors configured to execute the program steps so as to:
provide or publish at least two of shareable labeling functions with their profile across domains, wherein each of the at least two shareable labeling function profiles includes at least one training-related performance metric and/or weight;
select at least one of the at least two shareable labeling functions by a selecting domain, wherein the selecting is based on respective at least one training-related performance metric and/or weight of the at least two shareable labeling functions;
group unlabeled data of the selecting domain for providing at least one group, wherein the grouping is based on a definable degree of coverage of the selected at least one shareable labeling function per unlabeled data and/or on a definable degree of coverage of unlabeled data per shareable labeling function; and
training a preferably generative machine learning model of the selecting domain per at least one group with the respective at least one training-related performance metric and/or weight for producing labeled data of at least one selected at least one shareable labeling functions.

16: The data programming method according to claim 1, wherein the AI system is a machine learning (ML) system.

17: The data programming method according to claim 4, wherein the correct labels are produced in terms of different types of machine learning measures, including at least one of accuracy, precision, recall and F1-score.

18: The data programming method according to claim 13, wherein the function catalog or the function catalog server comprises a global ontology and/or a function repository and/or a propagator.

19: The system for carrying out the data programming method according to claim 15, wherein the AI system is a machine learning (ML) system that carries out the data programming method.
